(19) United States
(12) Patent Application Publication
(10) Pub. No.: US 2003/0086660 A1
(43) Pub. Date: May 8, 2003

(54) Horizontal carrier assembly for multiple array optoelectronic devices

(75) Inventors: Johnny R. Brezina, Austin, TX (US); Brian M. Kerrigan, Austin, TX (US); Gerald D. Malagrino JR., Rochester, MN (US); James R. Moon, Oronoco, MN (US)

Correspondence Address: Frank C. Nicholas, CARDINAL LAW GROUP, Suite 2000, 1603 Orrington Avenue, Evanston, IL, 60201, US

(73) Assignee: International Business Machines Corporation, Armonk, NY

(21) Appl. No.: 10/007,215

(22) Filed: Nov. 5, 2001

(51) Int. Cl. G02B 6/42

(52) U.S. Cl. 385/88; 385/53

(57) ABSTRACT

An optical fiber link module comprises a die carrier, an input/output connector half, and a circuit cable. The die carrier has a generally planar edge, and at least one optical die is disposed on the edge of the die carrier. The input/output connector half has a generally planar surface disposed perpendicularly to the edge of the die carrier, and has an input/output connection. The circuit cable is connected between the optical die and the input/output connection.

### RELATED APPLICATIONS

This application claims priority to U.S. patent application Ser. No. 09/956,771 filed on Sep. 20, 2001 entitled “Fiber Optic Transceiver, Connector, And Method of Dissipating Heat” by Johnny R. Brezina, et al., the entire disclosure of which is incorporated by reference, herein.

This application also relates to the following applications, filed concurrently herewith:

“Optical Alignment In A Fiber Optic Transceiver”, by Johnny R. Brezina, et al. (IBM Docket No. AUS920010689US1);

“External EMI Shield For Multiple Array Optoelectronic Devices”, by Johnny R. Brezina, et al. (IBM Docket No. AUS920010690US1);

“Packaging Architecture For A Multiple Array Transceiver Using A Continuous Flexible Circuit”, by Johnny R. Brezina, et al. (IBM Docket No. AUS920010591 US1);

“Flexible Cable Stiffener for An Optical Transceiver”, by Johnny R. Brezina, et al. (IBM Docket No. AUS920010729US1);

“Enhanced Folded Flexible Cable Packaging for Use in Optical Transceivers, by Johnny R. Brezina, et al. (IBM Docket No. AUS920010727US1);

“Apparatus and Method for Controlling an Optical Transceiver”, by Johnny R. Brezina, et al. (IBM Docket No. AUS920010728US1);

“Internal EMI Shield for Multiple Array Optoelectronic Devices”, by Johnny R. Brezina, et al. (IBM Docket No. AUS920010730US1);

“Multiple Array Optoelectronic Connector with Integrated Latch”, by Johnny R. Brezina, et al. (IBM Docket No. AUS920010731 US1);

“Mounting a Lens Array in a Fiber Optic Transceiver”, by Johnny R. Brezina, et al. (IBM Docket No. AUS920010733US1);

“Packaging Architecture for a Multiple Array Transceiver Using a Flexible Cable”, by Johnny R. Brezina, et al. (IBM Docket No. AUS920010734US1);

“Packaging Architecture for a Multiple Array Transceiver Using a Flexible Cable and Stiffener for Customer Attachment”, by Johnny R. Brezina, et al. (IBM Docket No. AUS920010735US1); and

“Packaging Architecture for a Multiple Array Transceiver Using a Winged Flexible Cable for Optimal Wiring”, by Johnny R. Brezina, et al. (IBM Docket No. AUS920010736US1).

### TECHNICAL FIELD OF THE INVENTION

This invention is generally related to multiple array optoelectronic devices, and more particularly related to a horizontal carrier assembly for multiple array optoelectronic devices.

### BACKGROUND OF THE INVENTION

Optical fiber is widely used to rapidly and reliably transfer data between computer systems. In general, an optical fiber includes a core region that is coated by an annular clad. The core region has an index of refraction greater than that of the clad, so that light is transmitted through the core by total internal refraction. Optical fibers transmit data from an optoelectronic transducer, such as a laser or Light Emitting Diode (LED), to an optoelectronic receiver that generates electrical information based upon the signal received.

Optical link modules may be mounted within a component such as a router in order to transfer this data at relatively high speeds. Frequently, the user of the computer system desires to connect a board or card at a location proximate the optical dies of the optical link module, and specifications for making this connection may call for mounting holes to be provided. The provision of these mounting holes can present a problem, particularly in the case where user cards of various thicknesses must be accommodated.

### SUMMARY OF THE INVENTION

The present invention is an optical fiber link module comprising a die carrier, an input/output connector half, and a circuit cable. The die carrier has a generally planar edge, and at least one optical die is disposed on the edge of the die carrier. The input/output connector half has a generally planar surface disposed perpendicularly to the edge of the die carrier, and has an input/output connection. The circuit cable is connected between the optical die and the input/output connection.

It is an object of the present invention to provide an optical fiber link module of the type described above in which the die carrier has a generally horizontal disposition.

Another object of the present invention is to provide an optical fiber link module of the type described above in which the horizontal position of the die carrier permits a long length of engagement of mounting screw to connect a user card or board.

Still another object of the present invention is to provide an optical fiber link module of the type described above in which the optical die and the input/output connector half are arranged generally perpendicularly.

Still another object of the present invention is to provide an optical fiber link module of the type described above that can be easily assembled.

These and other advantages and features, which characterize the invention, are set forth in the claims annexed hereto and forming a further part hereof. However, for a better understanding of the invention, and of the advantages and objectives attained through its use, reference should be made to the drawings, and to the accompanying descriptive matter, in which there is described exemplary embodiments of the invention.

### BRIEF DESCRIPTION OF THE DRAWINGS

FIG. 1 is a perspective view showing an optical link module according to the present invention;

FIG. 2 is a perspective view of the underside of the optical link module;

FIG. 3 is a perspective view of a portion of the optical link module;

FIG. 4 is a perspective view of the upper side of the portion shown in FIG. 3;

FIG. 5 is a perspective view of a lens housing assembly of the module; and

FIG. 6 is a perspective view of the lens housing assembly attached to the module.

### DETAILED DESCRIPTION OF THE INVENTION

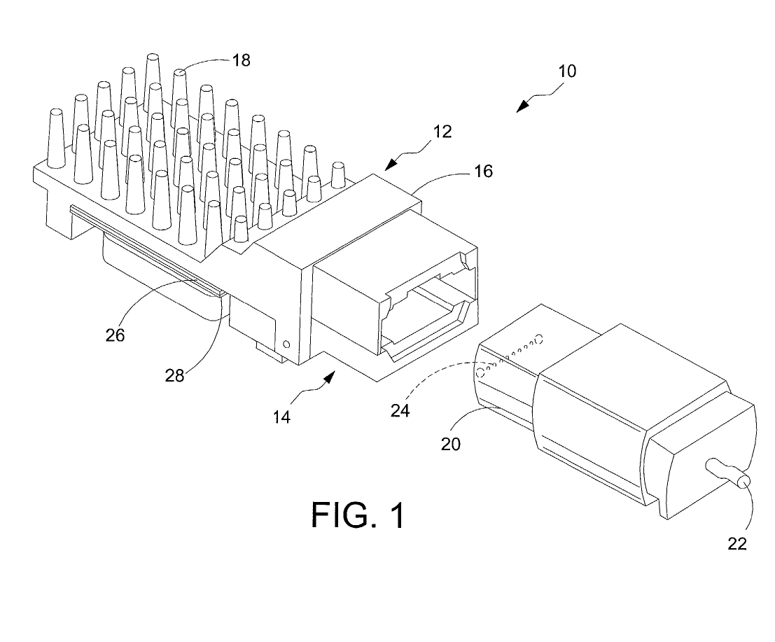

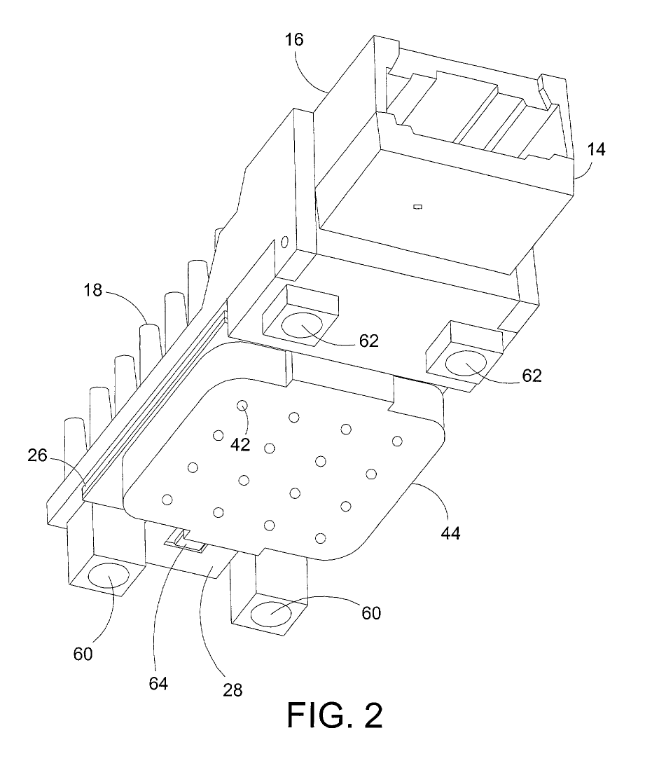

FIGS. 1 and 2 show the general configuration of an exemplary optical link module 10. Optical link module 10 represents a fiber optic communications package which is mounted within a component such as a router that transfers data to and from another component of the router or other computer systems such as network servers, mid-range computers, mainframe computers, work stations, desktop computers, portable computers, and the like.

The optical link module 10 generally includes an upper portion 12 and a lower portion 14. The upper portion 12 is preferably die cast as a single piece from a relatively high thermal conductivity material such as aluminum, and includes an upper connector 16 and a heat sink 18. The lower portion 14 of the module 10 is also preferably die cast, and may be joined to the upper portion 12 in any known fashion. Together, the upper connector 16 and the lower portion 14 form a female part of a standard MTP or MTO connector adapted to receive a male part 20 situated on the distal end of a fiber optic cable 22. In a preferred embodiment, the male end 20 of the fiber 22 includes a 2.5 gigahertz, four transmit and four receive channel multiple array 24 similar to that shown in U.S. Pat. No. 5,499,311, the disclosure of which is hereby incorporated by reference.

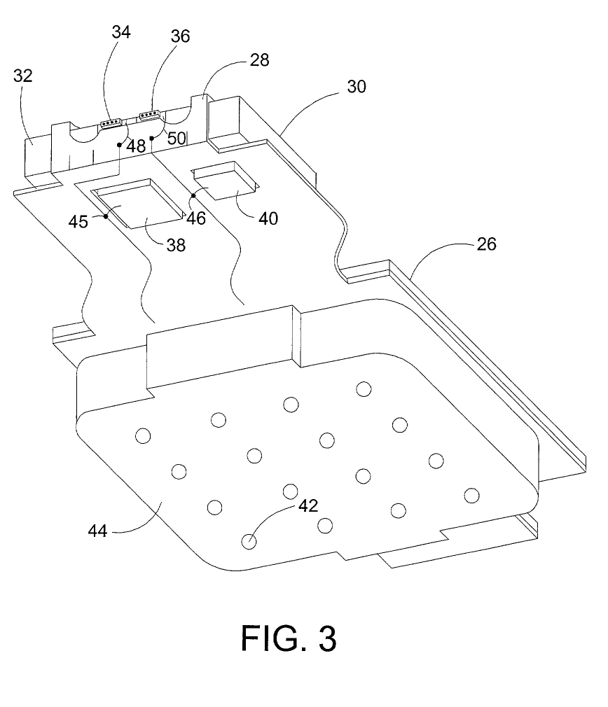

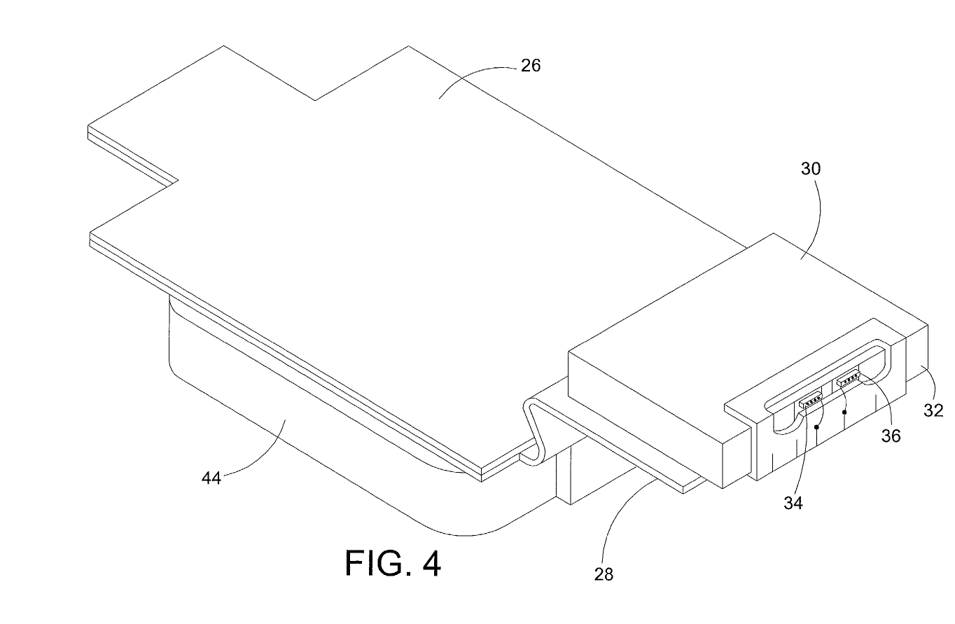

An aluminum stiffener 26 is provided on the underside of the heat sink 18, with a flexible circuit cable 28 attached thereto. As may best be seen in FIGS. 3 and 4, one end of the flexible cable 28 is bonded with an adhesive to a die carrier 30. The die carrier 30 preferably comprises an aluminum nitride ceramic with plated edge metallization. One edge 32 of the carrier is plated with bondable gold, and is used as the supply and ground planes for laser and photodetector optical dies 34 and 36, respectively. A laser drive amplifier (LDA) 38 and a transimpedance amplifier (TIA) or photodetector interface chip 40 are also die bonded to the carrier 30 in close proximity to the optical chips 38 and 40.

The flexible cable 28 electrically connects the forward, horizontally-oriented die carrier 30 with rearward horizontal input/output solder balls 42 mounted on an input/output connector half 44. Electrical connections between the optical dies 34 and 36 and their respective support chips 38 and 40 are achieved by bending the flexible cable 28 around the edge 32 of the carrier 30, and wire bonding to provide transmission line interconnections. To this end, the flexible cable 28 has bond pads 45 and 46 near the LDA and TIA chips 38 and 40 to allow wire bonding between the chips and traces on the flexible cable 28. Similar bond pads are exposed proximate the edge 32 of the carrier 30 to allow wires 48 and 50 between the flexible cable 28 and the optical dies 34 and 36.

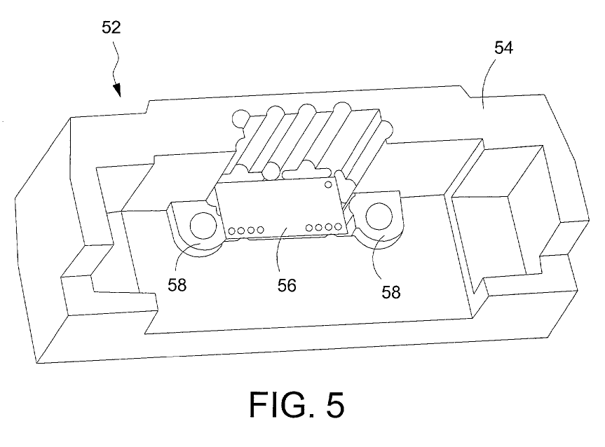

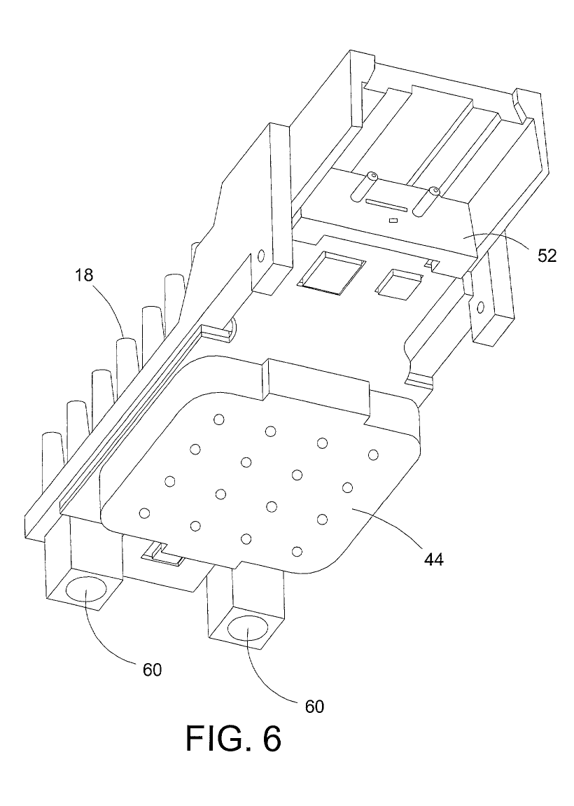

FIG. 5 shows the interior of an optical lens assembly 52 comprising a plastic housing 54 and an etched lens 56 that is alignable with the optical dies 34 and 36. Preferably, an ultraviolet-cure epoxy is used to bond the lens assembly 52 to the carrier 30 at its ends and at alignment pin boss interfaces 58, thus establishing a mechanical datum to the two optical dies. FIG. 6 shows the optical lens assembly 52 mated to the carrier 30. The horizontal position of the carrier 30 allows a variety of lens designs to be used in the module 10.

Referring again in particular to FIG. 2, the upper connector portion 16 is provided with a pair of rearward mounting screw holes 60, and the lower connector portion 14 is provided with a similar pair of forward mounting screw holes 62. The flexible cable 28 is situated above the mounting screw locations, allowing screws to secure an attachable user board or card (not shown) from below. An electronically erasable programmable read only memory (EEPROM) 64 and/or other drive or amplification components are die bonded to the stiffener 26 near the rearward portion of the flexible cable 28. Input/output and EEPROM circuit traces may be routed to the array of solder balls 42, as is well known. Heat generated by the EEPROM die or other component dies is dissipated into the stiffener 26, which in turn is connected to the base of the heatsink 18. The module 10 is thus thermally efficient, with one mass flow path from the carrier 30 through the heatsink 18 and a second, parallel path through the stiffener 26 and to the rearward portion of the heatsink.

The module 10 can be assembled in a “top down” fashion. The heatsink base casting 12 first receives the stiffener 26, flexible cable 28 and carrier 30, including the lens assembly 52, to give the structure shown generally in FIG. 6. The lower connector half 14 is then oriented and assembled to the base 12, and held in place with two press fit assembly pins. An electromagnetic interference (EMI) assembly clip (not shown) may then be disposed over the retainer end to provide both EMI and ground connection points to the bulkhead of a chassis (not shown). This “top down” assembly is relatively simple and inexpensive.

The ball grid array connector half 44 is adapted to connect to a matching ball grid array connector half on the user board, and to be secured thereto by screw or other suitable fasteners extending into the screw locations 60 and 62. Because the screw holes 60 and 62 are relatively long, a great variety of card thicknesses can be accommodated. The resulting assembly provides a generally perpendicular orientation between the plane of the optical dies 34 and 36 and the plane of the user board, with the flexible cable 28 bent to provide the electrical connection.

The flexible cable 28 may carry other integrated circuit chips, resistors and other structure which, together with the structure shown, operate to convert and route the fiber optic light signals from the fiber 22 to and from other areas of the router system of which the module 10 is a part. Although the details of such conversion and routing are considered to be well within the level of ordinary skill in the art, further information is available in U.S. Pat. No. 6,085,006, the disclosure of which is hereby incorporated by reference. Normally, the module 10 receives electrical signals from a host board, and the laser driver 38 then drives the laser or LED 34, converting the electrical signal to an optical signal for transmission through the optical fiber 22. Similarly, incoming optical signals are converted by the photodetector 36 to a serial electrical signal and then amplified through the TIA 40 and/or other post-amplification device. The electrical signal may be output to the host board as a serial signal or converted to a parallel electrical signal.

It should be appreciated that the present invention can be implemented in a number of ways. Furthermore, the optical link module is also suitable for use in other communications systems or optical transmission networks, such as those used in telephone service. Various modifications may be made to the illustrated embodiments without departing from the spirit and scope of the invention. Therefore, the invention lies solely in the claims hereinafter appended.

What is claimed is:

1. An optical fiber link module comprising:
a die carrier having a generally planar edge;
at least one optical die disposed on the edge of the die carrier;
an input/output connector half having a generally planar surface disposed perpendicularly to the edge of the die carrier, the input/output connector half surface having an input/output connection; and
a circuit cable connected between the optical die and the input/output connection.

2. The optical fiber link module of claim 1 wherein the die carrier comprises a ceramic.

3. The optical fiber link module of claim 1 wherein the die carrier comprises aluminum nitride.

4. The optical fiber link module of claim 1 wherein the die carrier comprises an aluminum nitride ceramic.

5. The optical fiber link module of claim 1 wherein the optical die comprises a laser.

6. The optical fiber link module of claim 1 wherein the optical die comprises a photodetector.

7. The optical fiber link module of claim 1 further comprising an upper fiber connector portion and a lower fiber connector portion connected to the die carrier, the upper and lower fiber connector portions being adapted to receive an optical fiber.

8. The optical fiber link module of claim 7 wherein the upper fiber connector portion includes at least one fastener accepting hole.

9. The optical fiber link module of claim 7 wherein the lower connection portion includes at least one fastener accepting hole.

10. An optical fiber link module comprising:
a die carrier having a generally planar edge;
a multiple array lens disposed on the edge of the die carrier;
an input/output connector half having a generally planar surface disposed perpendicularly to the edge of the die carrier, the input/output connector half surface having an input/output connection; and
a circuit cable connected between the multiple array lens and the input/output connection.

11. The optical fiber link module of claim 10 wherein the die carrier comprises a ceramic.

12. The optical fiber link module of claim 10 wherein the die carrier comprises aluminum nitride.

13. The optical fiber link module of claim 10 wherein the die carrier comprises an aluminum nitride ceramic.

14. The optical fiber link module of claim 10 wherein the multiple array comprises a laser.

15. The optical fiber link module of claim 10 wherein the multiple array comprises a photodetector.

16. The optical fiber link module of claim 10 further comprising an upper fiber connector portion and a lower fiber connector portion connected to the die carrier, the upper and lower fiber connector portions being adapted to receive an optical fiber.

17. The optical fiber link module of claim 16 wherein the upper fiber connector portion includes at least one fastener accepting hole.

18. The optical fiber link module of claim 16 wherein the lower connection portion includes at least one fastener accepting hole.

19. An optical fiber link module comprising:
an optical fiber;
a ceramic die carrier having a generally planar edge;
a multiple array lens disposed on the edge of the die carrier, the multiple array including at least one laser and at least one photodetector;
an input/output connector half having a generally planar surface disposed perpendicularly to the edge of the die carrier, the input/output connector half surface having an input/output connection;
a circuit cable connected between the multiple array lens and the input/output connection; and
an upper fiber connector portion and a lower fiber connector portion connected to the die carrier, the upper and lower fiber connector portions being adapted to receive an optical fiber.

20. The optical fiber link module of claim 19 wherein the upper fiber connector portion and the lower fiber connector portion each includes at least one fastener accepting hole.
